(19) United States
(12) Patent Application Publication
(10) Pub. No.: US 2025/0033144 A1
(43) Pub. Date: Jan. 30, 2025

(54) WELDING DEVICE

(71) Applicant: LG ENERGY SOLUTION, LTD., Seoul (KR)

(72) Inventors: Chang-Je LEE, Daejeon (KR); Min-Jae KANG, Daejeon (KR); Na-Hee OH, Daejeon (KR)

(73) Assignee: LG ENERGY SOLUTION, LTD., Seoul (KR)

(21) Appl. No.: 18/716,412

(22) PCT Filed: Jul. 7, 2023
(86) PCT No.: PCT/KR2023/009710

§ 371 Date: Jun. 4, 2024

(30) Foreign Application Priority Data
Jul. 8, 2022 (KR) 10-2022-0084675
Jun. 26, 2023 (KR) 10-2023-0082154

(51) Int. Cl. B23K 26/082; B23K 26/26; B23K 101/38

(52) U.S. Cl. CPC B23K 26/082; B23K 26/26; B23K 2101/38

(57) ABSTRACT

A welding device for welding a plurality of materials arranged to be in contact includes a scanner configured to deflect light; a welding laser configured to emit light toward the scanner; a galvo module configured to deflect light toward the scanner; a scan laser configured to emit light toward the galvo module; and a processor configured to control at least one of the scanner and the galvo module to scan boundaries of the plurality of materials.

### TECHNICAL FIELD

The present disclosure relates to a welding device.

The present application claims priority to Korean Patent Application No. 10-2022-0084675 filed on Jul. 8, 2022, and Korean Patent Application No. 10-2023-0082154 filed on Jun. 26, 2023, the disclosures of which are incorporated herein by reference.

### BACKGROUND ART

Welding technology is widely used in various industrial fields. For example, in the battery field, welding technology is applied to welding between battery module cases or between leads and bus bars.

Welding is the coupling of two or more members or parts, and it is necessary to secure a certain level or higher of welding quality so that the coupling state may be maintained reliably. However, according to the conventional welding method, welding quality is often not secured stably.

In particular, the electrode leads of battery cells and bus bars may be coupled by laser welding. Also, the frame and end plate of a battery module or a battery module case may be coupled by laser welding. In this case, if the welding object is not placed precisely on the welding device or is misaligned, the welding work line may be deviated. Therefore, it is necessary to increase the accuracy of welding by appropriately calibrating or updating the welding work line before welding.

### DISCLOSURE

### Technical Problem

The present disclosure is designed to solve the above-described problems and other problems.

In particular, an object of the present disclosure may be to provide a welding device capable of increasing welding accuracy.

Another object of the present disclosure may be to provide a welding device capable of inspecting welding quality in real time while welding is in progress.

### Technical Solution

A welding device according to an aspect of the present disclosure for achieving the above-described object is a welding device for welding a plurality of materials arranged to be in contact, and may include a scanner configured to deflect light; a welding laser configured to emit light toward the scanner; a galvo module configured to deflect light toward the scanner; a scan laser configured to emit light toward the galvo module; and a processor configured to control at least one of the scanner and the galvo module to scan boundaries of the plurality of materials.

In addition, the processor may be configured to measure a distance between a focus at which the scanner is aimed and the scanner.

In addition, the processor may be configured to calibrate a preset welding work line based on coordinate information obtained by scanning the boundaries of the plurality of materials.

In addition, the processor may be configured to control the welding laser and the scanner to form a keyhole, and to control the scan laser and the galvo module to scan around the keyhole.

In addition, at least one of the plurality of materials may be a frame of a battery module.

In addition, the plurality of materials may include a first material; and a second material laminated on the first material and exposing a portion of an upper surface of the first material, wherein the welding device may further include a jig configured to bring the second material into contact with the first material.

In addition, the first material may be a bus bar, and the second material may be an electrode lead of a battery cell.

In addition, the jig may be configured to press the electrode lead, and a hole may be formed to penetrate the jig in a vertical direction, wherein the hole may be configured to expose at least a portion of the electrode lead and at least a portion of the bus bar.

In addition, the processor may be configured to calibrate a preset welding work line based on coordinate information obtained by scanning the boundary of the bus bar and the electrode lead.

In addition, the jig may include a first part configured to press the electrode lead; and a second part facing the first part.

In addition, the processor may be configured to calibrate a preset welding work line based on coordinate information obtained by scanning the first part and the second part.

A battery cell according to the present disclosure is welded through the welding device of the present disclosure.

In addition, a battery module according to the present disclosure is welded through the welding device of the present disclosure.

In addition, a battery cell manufacturing device according to the present disclosure includes the welding device according to the present disclosure.

In addition, a battery module manufacturing device according to the present disclosure includes the welding device according to the present disclosure.

In addition, a welding method according to the present disclosure uses the welding device according to the present disclosure.

The processor may be further configured to cause the scan laser to oscillate.

The processor may be further configured to calibrate an existing welding work line to a center line of the jig.

### Advantageous Effects

According to at least one of the embodiments of the present disclosure, welding accuracy may be improved.

According to at least one of the embodiments of the present disclosure, welding accuracy may be improved by appropriately calibrating or updating the welding work line even if the welding object is misaligned.

According to at least one of the embodiments of the present disclosure, welding defects may be quickly and accurately sensed.

### DESCRIPTION OF DRAWINGS

The accompanying drawings illustrate a preferred embodiment of the present disclosure and together with the foregoing disclosure, serve to provide further understanding of the technical features of the present disclosure, and thus the present disclosure is not construed as being limited to the drawing.

FIG. 1 is a view showing a partial configuration of a welding device according to an embodiment of the present disclosure.

FIG. 2 is a view schematically showing an optical configuration of a welding device according to an embodiment of the present disclosure.

FIG. 3 is an exploded view showing a partial configuration of a battery module welded by a welding device according to an embodiment of the present disclosure.

FIG. 4 is a perspective view showing the battery module of FIG. 3.

FIG. 5 is an exploded view showing a partial configuration of another battery module welded by a welding device according to an embodiment of the present disclosure.

FIG. 6 is a perspective view showing the battery module of FIG. 5.

FIG. 7 is a view showing an example in which a battery module is scanned by a welding device according to an embodiment of the present disclosure.

FIG. 8 is a view showing an example in which a welding line is calibrated by a welding device according to an embodiment of the present disclosure.

FIG. 9 is a view showing an example in which a battery module is welded by a welding device according to an embodiment of the present disclosure.

FIG. 10 is a view showing an example in which a welding portion is inspected by a welding device according to an embodiment of the present disclosure.

FIG. 11 is a view showing a bus bar and an electrode lead welded by a welding device according to an embodiment of the present disclosure.

FIG. 12 is a view showing a bus bar and an electrode lead aligned by a welding device according to an embodiment of the present disclosure.

FIG. 13 is a view showing a bus bar and an electrode lead scanned by a welding device according to an embodiment of the present disclosure.

FIG. 14 is a view showing an example in which a welding line is calibrated by a welding device according to an embodiment of the present disclosure.

FIG. 15 is a view showing a bus bar and an electrode lead scanned by a welding device according to another embodiment of the present disclosure.

FIG. 16 is a view showing an example in which a welding line is calibrated by a welding device according to another embodiment of the present disclosure.

FIG. 17 is a view showing a bus bar and an electrode lead scanned by a welding device according to still another embodiment of the present disclosure.

FIG. 18 is a view showing an example in which a welding line is calibrated by a welding device according to still another embodiment of the present disclosure.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

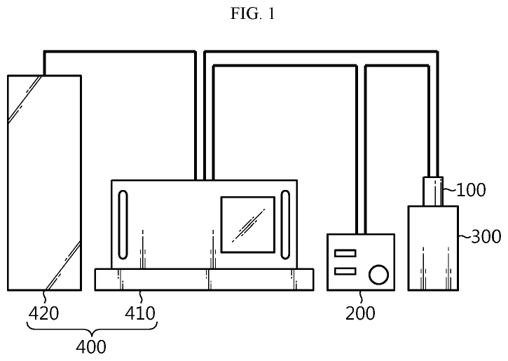

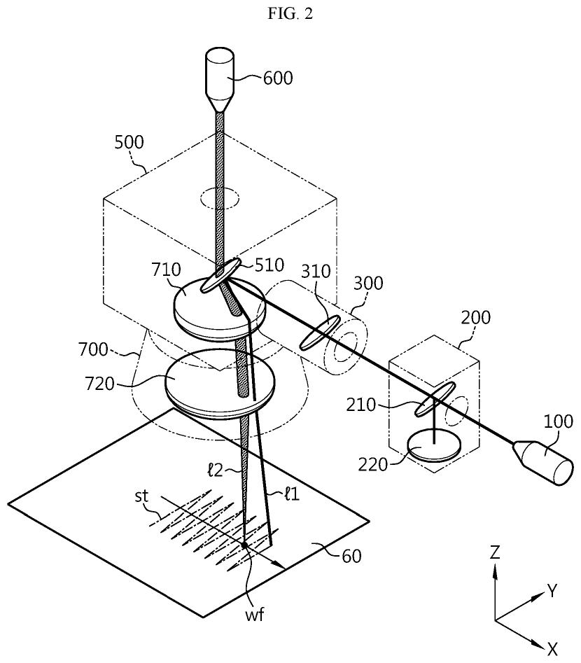

FIG. 1 is a view showing a partial configuration of a welding device according to an embodiment of the present disclosure. FIG. 2 is a view schematically showing an optical configuration of a welding device according to an embodiment of the present disclosure. Referring to FIGS. 1 and 2, a welding device according to an embodiment of the present disclosure is a welding device for welding a plurality of materials 60 arranged to be in contact. Also, the welding device according to an embodiment of the present disclosure may include a scanner 500, a welding laser 600, a galvo module 300, a scan laser 100, and a processor 400.

The plurality of materials 60 may be disposed to be in contact for butt welding, edge welding, fringe welding, or overlap welding. The meaning of contact refers to the positional relationship of the plurality of materials 60 for welding, and the type of welding joint is not limited.

The scanner 500 may be configured to deflect light. The scanner 500 may include a scan mirror 510 therein. The scan mirror 510 may deflect light incident on the scanner 500. Also, the scan mirror 510 may be configured to be rotatable. The scan mirror 510 may be configured to deflect light in various directions.

The welding laser 600 may output light 12. The welding laser 600 may emit light 12 toward the scanner 500. The light 12 emitted by the welding laser 600 may have an intensity high enough to weld the plurality of materials 60.

The galvo module 300 may be configured to deflect light. The galvo module 300 may include a galvo mirror 310 therein. The galvo mirror 310 may deflect light incident on the galvo module 300. In addition, the galvo mirror 310 may be configured to be rotatable. The galvo mirror 310 may be configured to deflect light in various directions. Also, the galvo module 300 may be configured to deflect the incident light toward the scanner 500. In addition, the galvo module 300 may be configured to be fastened, coupled, fixed, or assembled to one side of the scanner 500.

The scan laser 100 may output light 11. The scan laser 100 may emit light 11 toward the galvo module 300. The light 11 emitted by the scan laser 100 may have a weaker intensity than the light 12 emitted by the welding laser 600. In addition, the scan laser 100 may output light 11 having a wavelength different from that of the welding laser 600. For example, the scan laser 100 may output visible light. The scan laser 100 may output light 11 for scanning the shape, location, surface, or boundary of the plurality of materials 60. In addition, the scan laser 100 may be configured to scan around the focus of the light 12 emitted by the welding laser 600.

The processor 400 may be configured to include a first control computer 410 and a second control computer 420. The first control computer 410 may be physically, electrically, or optically connected to at least one of the scanner 500, the welding laser 600, the scan laser 100, or the galvo module 300. The first control computer 410 may be configured to monitor or control at least one of the scanner 500, the welding laser 600, the scan laser 100, or the galvo module 300. The second control computer 420 may be physically, electrically, or optically connected to the first control computer 410. The second control computer 420 may be configured to monitor or control the first control computer 410. In addition, the second control computer 420 may include an interface unit capable of receiving commands from a user. The processor 400 may be used to refer to the first control computer 410 and the second control computer 420.

The processor 400 may be configured to scan the boundaries of the plurality of materials 60 by controlling at least one of the scanner 500 and the galvo module 300. In this case, the processor 400 may turn off the output of the welding laser 600 and turn on the output of the scan laser 100. The processor 400 may scan the boundaries of the plurality of materials 60 before welding the plurality of materials 60.

According to this configuration of the present disclosure, the processor 400 may scan, detect, sense, or recognize a welding work line before welding. The processor 400 may perform a more sophisticated welding operation by scanning the boundaries of the plurality of materials 60.

Referring to FIGS. 1 and 2, the welding device according to an embodiment of the present disclosure may be configured to further include an optical module 200 or a condensing module 700.

The scan laser 100 may be configured to emit light 11 toward the optical module 200. The optical module 200 may output, deflect, or pass at least a portion of the incident light toward the galvo module 300. The optical module 200 may be configured to include a beam splitter 210, a reference mirror 220, and a detector (not shown). The beam splitter 210 may output, deflect, or pass at least a portion of the light incident on the optical module 200 toward the galvo mirror 310. In addition, the beam splitter 210 may output, deflect, or pass at least a portion of the light incident on the optical module 200 toward the reference mirror 220. The reference mirror 220 may be configured to reflect the incident light toward the detector. The processor 400 may be configured to acquire optical coherence tomography (OCT) through the optical module 200.

The condensing module 700 may be configured to be fastened, coupled, fixed, or assembled to one side of the scanner 500. The condensing module 700 may be configured to include a first condensing lens 710 and a second condensing lens 720. The condensing module 700 may be configured to focus light deflected by the scanner 500 toward a plurality of materials. The light 12 output from the welding laser 600 and the light 11 output from the scan laser 100 may be focused on the plurality of materials 60 through the condensing module 700.

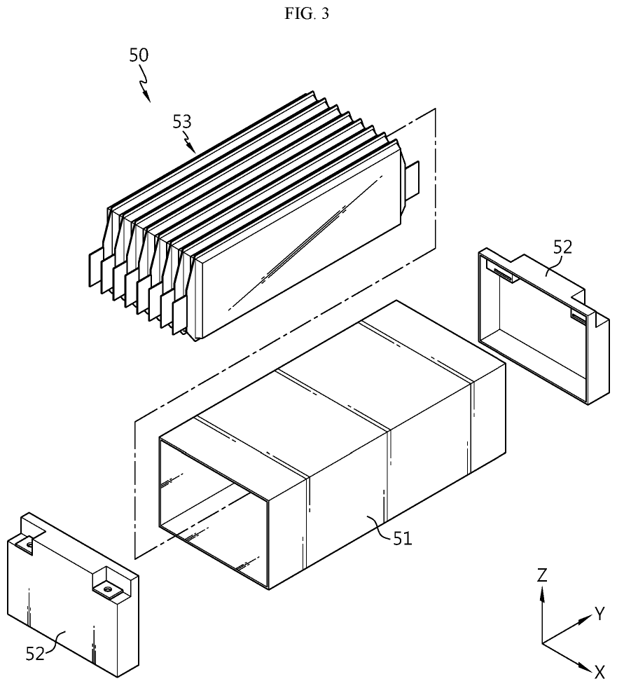

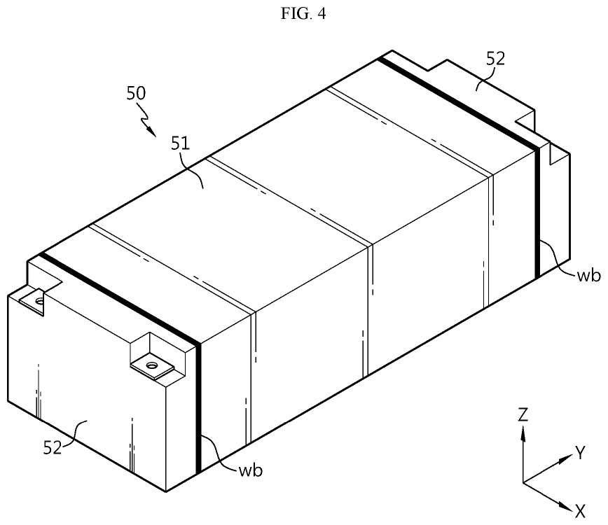

FIG. 3 is an exploded view showing a partial configuration of a battery module 50 welded by a welding device according to an embodiment of the present disclosure. FIG. 4 is a perspective view showing the battery module 50 of FIG. 3. Referring to FIGS. 3 and 4, a battery module 50 welded by a welding device according to an embodiment of the present disclosure may be configured to include a frame 51, an end plate 52, and a plurality of cells 53.

The frame 51 may have a rectangular parallelepiped shape that is open in the vertical direction, in the front-rear direction, or in the Y-axis direction. Also, the frame 51 may provide space therein. The frame 51 may be made of a metal material.

The end plate 52 may be fastened, coupled, or fixed to the frame 51 on the front side and the rear side, respectively. The end plate 52 and the frame 51 may be coupled through welding. A welding line wb or a welding portion wb may be formed along the perimeter of the end plate 52, the perimeter of the front side of the frame 51, or the perimeter of the rear side of the frame 51.

A plurality of battery cells 53 may be accommodated in an inner space of the frame 51. The plurality of battery cells 53 may refer to secondary batteries. The plurality of battery cells 53 may be secondary batteries having a pouch shape. The plurality of battery cells 53 may be configured to be stacked inside the frame 51.

The welding device according to an embodiment of the present disclosure may be configured to form a welding line wb or a welding portion wb of the battery module 50.

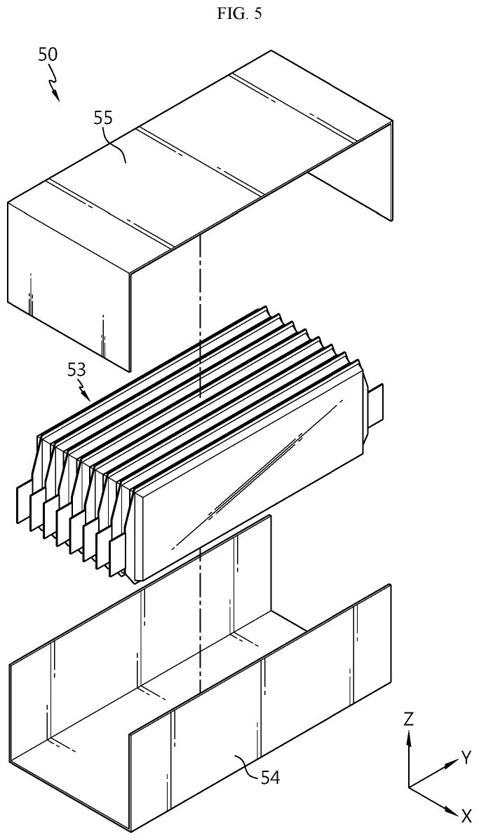

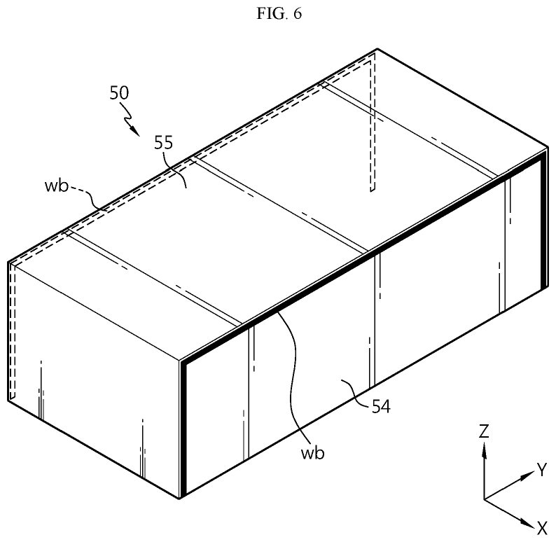

FIG. 5 is an exploded view showing a partial configuration of another battery module 50 welded by a welding device according to an embodiment of the present disclosure. FIG. 6 is a perspective view showing the battery module 50 of FIG. 5. Referring to FIGS. 5 and 6, a battery module 50 welded by a welding device according to an embodiment of the present disclosure may be configured to include a U-frame 54, a top frame 55, and a plurality of cells 53.

The U-frame 54 may have a U-shape. The U-frame 54 may be open in the vertical direction, in the front-rear direction, or in the Y-axis direction. In addition, the U-frame 54 may be open upward or in the +Z-axis direction. Also, the U-frame 54 may provide space therein. The U-frame 54 may be made of a metal material.

The top frame 55 may be fastened, coupled, or fixed to the U-frame 54. The top frame 55 and the U-frame 54 may be coupled through welding. The top frame 55 and the U-frame 54 may have space, respectively. Also, the top frame 55 and the U-frame 54 may be fastened, coupled, or fixed to form a rectangular parallelepiped shape. A welding line wb or a welding portion wb may be formed along the edge of the U-frame 54 or along the edge of the top frame 55.

A plurality of battery cells 53 may be accommodated in an inner space formed by the U-frame 54 and the top frame 55. The plurality of battery cells 53 may refer to secondary batteries. The plurality of battery cells 53 may be secondary batteries having a pouch shape. The plurality of battery cells 53 may be configured to be stacked in the inner space formed by the U-frame 54 and the top frame 55.

The welding device according to an embodiment of the present disclosure may be configured to form a welding line wb or a welding portion wb of the battery module 50.

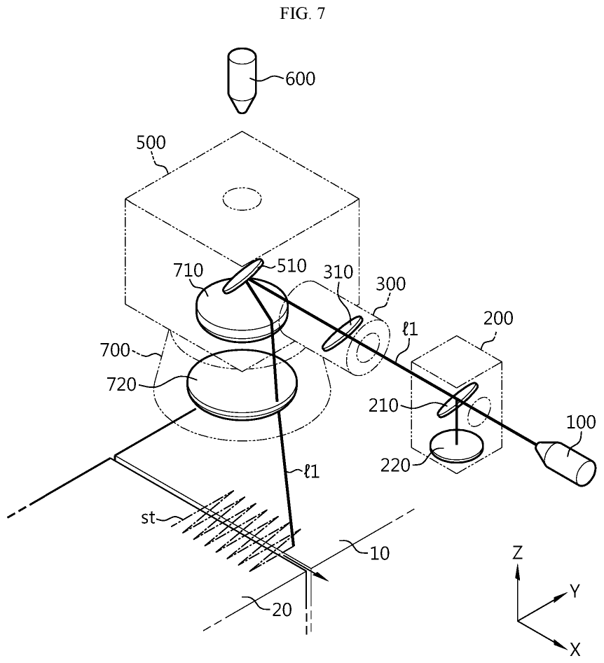

FIG. 7 is a view showing an example in which a battery module is scanned by a welding device according to an embodiment of the present disclosure. Referring to FIGS. 1 and 7, the processor 400 of the welding device according to an embodiment of the present disclosure may be configured to measure a distance between the focus wf at which the scanner 500 is aimed and the scanner 500. The welding device may be configured to weld the first material 10 and the second material 20. The first material 10 and the second material 20 may be made of a metal material. Also, the first material 10 and the second material 20 may be in contact for welding. For example, the first material 10 and the second material 20 may be the frame 51, U-frame 54, top frame 55, or end plate 52 of the battery module 50.

The processor 400 may scan the first material 10 and the second material 20 by controlling at least one of the scanner 500 and the galvo module 300 while turning on the scan laser 100 and turning off the welding laser 600. In this case, the scan trajectory st may be formed to vibrate in the Y-axis direction around the boundary of the first material 10 and the second material 20 and proceed in the +X-axis direction. The processor 400 may sense, recognize, or search the boundary of the first material 10 and the second material 20 by measuring a distance between the focus wf of the scanner 500 and the scanner 500. Alternatively, the processor 400 may sense, recognize, or search a gap formed between the first material 10 and the second material 20.

According to this configuration of the present disclosure, the processor 400 may scan, detect, sense, or recognize the welding work line before welding. The processor 400 may perform a more sophisticated welding operation by scanning the boundaries or gaps of the plurality of materials 10, 20.

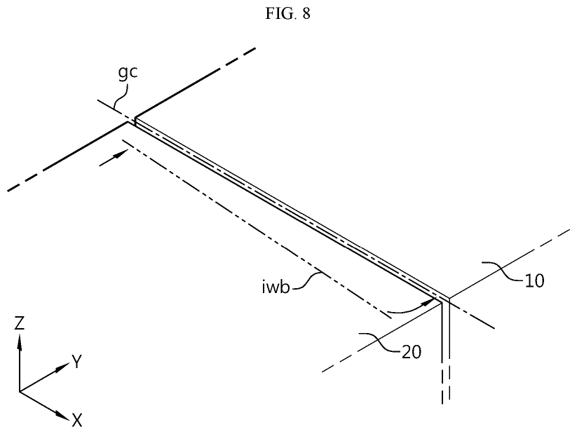

FIG. 8 is a view showing an example in which a welding line is calibrated by a welding device according to an embodiment of the present disclosure. Referring to FIGS. 1 and 8, the processor 400 of the welding device according to an embodiment of the present disclosure may be configured to calibrate the preset welding work line iwb based on coordinate information obtained by scanning the boundaries of the plurality of materials 10, 20.

The processor 400 may be configured to include the previously established, stored, and set welding work line iwb information. In this case, the welding work line iwb information may be coordinate information on the X-Y plane. In addition, the processor 400 may be configured to calibrate or update the previously established, stored, and set welding work line iwb based on coordinate information obtained by scanning the boundaries of the plurality of materials 10, 20. For example, the processor 400 may calibrate or update the existing welding work line iwb to the center line gc of the gap or boundary between the first material 10 and the second material 20. Also, the processor 400 may be configured to perform a welding operation along the calibrated or updated welding work line gc.

According to this configuration of the present disclosure, the processor 400 may improve welding quality and reduce welding defects by calibrating or updating the welding work line iwb.

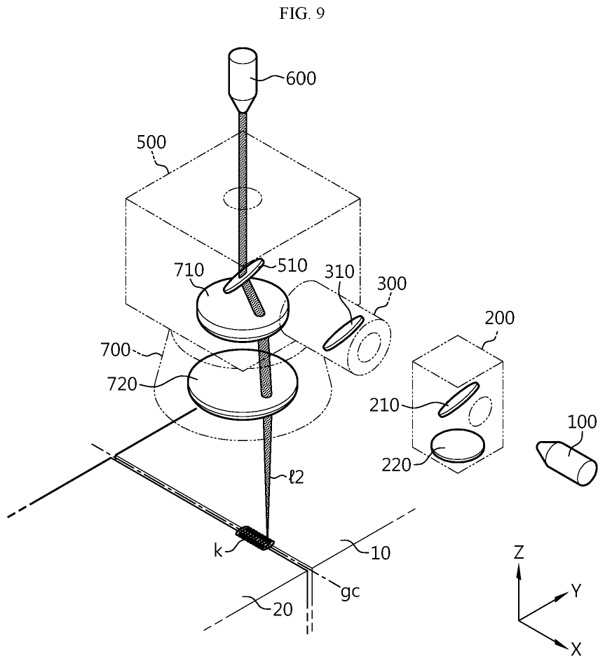

FIG. 9 is a view showing an example in which a battery module is welded by a welding device according to an embodiment of the present disclosure. Referring to FIGS. 1 and 9, the processor 400 of the welding device according to an embodiment of the present disclosure may be configured to control the welding laser 600 and the scanner 500 to form a keyhole k, and to control the scan laser 100 and the galvo module 300 to scan around the keyhole k.

The processor 400 may turn on the welding laser 600 and control the scanner 500 to weld the first material 10 and the second material 20. In this case, the processor 400 may control the welding laser 600 and the scanner 500 so that welding proceeds along the calibrated or updated welding work line gc. The processor 400 may form a welding spot, joint, a welding portion, or a keyhole k in the gap or boundary between the first material 10 and the second material 20.

According to this configuration of the present disclosure, the processor 400 may perform welding by calibrating or updating the welding work line iwb, thereby improving welding quality and reducing welding defects.

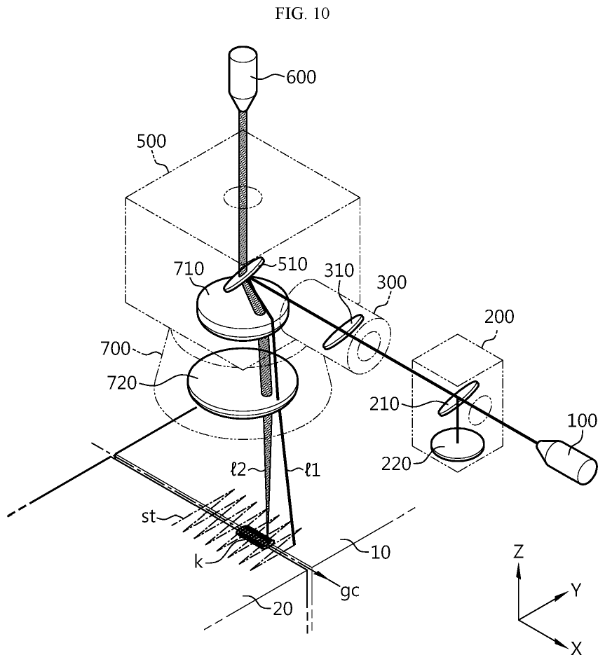

FIG. 10 is a view showing an example in which a welding portion is inspected by a welding device according to an embodiment of the present disclosure. Referring to FIGS. 1 and 10, the processor 400 of the welding device according to an embodiment of the present disclosure may be configured to perform welding quality inspection while simultaneously performing welding.

While welding is in progress, the processor 400 may turn on the scan laser 100 and vibrate the light 11 in the Y-axis direction around the welding spot, joint, welding portion, or keyhole k to proceed with the scan. In this case, the processor 400 may control the galvo module 300 to deflect the light 11 emitted from the scan laser 100. The processor 400 may be configured to control at least one of the scan laser 100 and the galvo module 300 to sense or measure the penetration depth of the welding spot, joint, welding portion, or keyhole k. The welding quality inspection may proceed along the direction of welding progress.

According to this configuration of the present disclosure, the processor 400 may quickly sense welding defects by performing welding quality inspection while simultaneously performing welding. As a result, welding defects may be quickly corrected or the settings of the welding device may be quickly corrected.

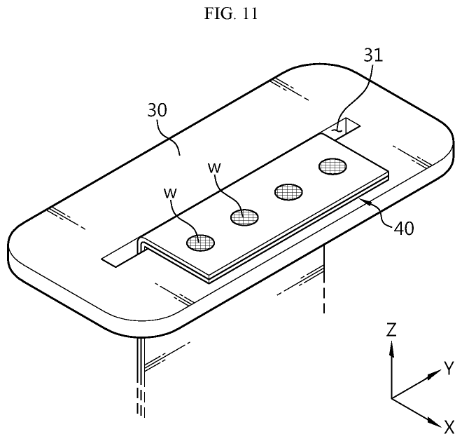

FIG. 11 is a view showing a bus bar 30 and an electrode lead 40 welded by a welding device according to an embodiment of the present disclosure. Referring to FIG. 11, the bus bar 30 may be physically and electrically coupled or connected to one or more electrode leads 40. The bus bar 30 may be in a configuration that is included in the battery module 50. Also, the electrode lead 40 may be in a configuration that is included in the battery cell 53. The bus bar 30 and the electrode lead 40 may be coupled by welding. The electrode lead 40 may pass through the hole 31 of the bus bar 30 and then be bent to be coupled or connected to the bus bar 30. The bus bar 30 and the electrode lead 40 may be coupled or connected through a plurality of welding spots w, joints w, or welding portions w.

According to this configuration of the present disclosure, the welding device according to an embodiment of the present disclosure may be configured to weld one or more electrode leads 40 to the bus bar 30.

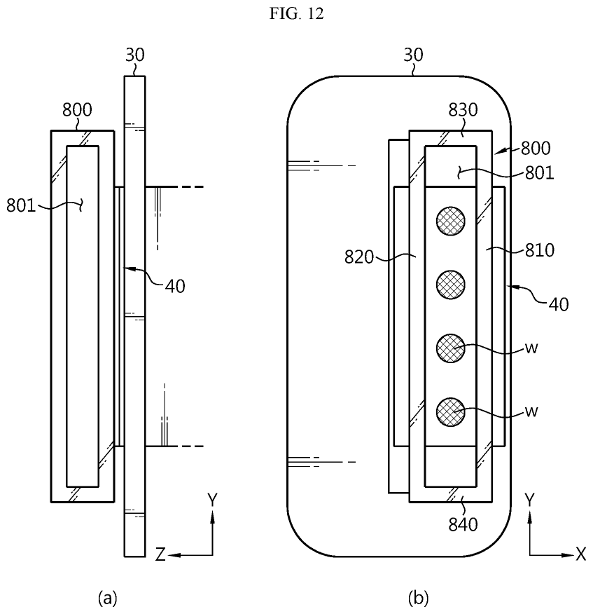

FIG. 12 is a view showing a bus bar 30 and an electrode lead 40 aligned by a welding device according to an embodiment of the present disclosure. FIG. 12 (a) is a view showing that the jig 800 brings the electrode lead 40 into close contact with the bus bar 30. FIG. 12 (b) is a view showing the jig 800 that brings the electrode lead 40 into close contact with the bus bar 30 when viewed from above. Referring to FIGS. 1 and 12, the welding device according to an embodiment of the present disclosure may be configured to further include a jig 800. The jig 800 may refer to a masking jig 800. In this case, the plurality of materials welded by the welding device of the present disclosure may include a first material and a second material laminated on the first material and exposing a portion of the upper surface of the first material. For example, the first material may be a bus bar 30, and the second material may be an electrode lead 40. Also, the jig 800 may bring the second material 40 into close contact with the first material 30. For example, the jig 800 may bring the electrode lead 40 into close contact with the bus bar 30. In this case, the electrode lead 40 may be bent to be in close contact with the bus bar 30. The processor 400 may be configured to control the movement of the jig 800. Also, the processor 400 may form a welding portion w, a welding spot w, or a joint w that connects or couples the busbar 30 and the electrode lead 40.

In this case, the boundary of the first material 30 and the second material 40 may refer to the perimeter or edge of the second material 40 that overlaps or is stacked on the first material 30. For example, the boundary of the bus bar 30 and the electrode lead 40 may be the perimeter or edge of a portion of the electrode lead 40 that overlaps or is stacked on the bus bar 30. The processor 400 may scan the perimeter or edge of the portion of the electrode lead 40 that overlaps or is stacked on the bus bar 30.

According to this configuration of the present disclosure, the processor 400 may scan, detect, sense, or recognize the welding work line before welding. The processor 400 may perform a more sophisticated welding operation by scanning the boundary of the bus bar 30 and the electrode lead 40.

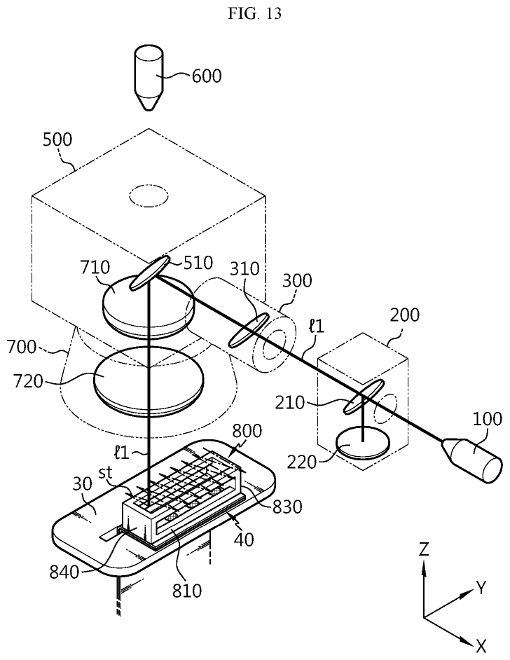

FIG. 13 is a view showing a bus bar 30 and an electrode lead 40 scanned by a welding device according to an embodiment of the present disclosure. Referring to FIGS. 1, 12, and 13, the jig 800 of the welding device according to an embodiment of the present disclosure may be configured to press the electrode lead 40 and may be configured such that a hole 801 is formed to penetrate in the vertical direction. Also, the hole 801 may be configured to expose at least a portion of the electrode lead.

The processor 400 may scan around the jig 800 by controlling at least one of the scanner 500 and the galvo module 300 while turning on the scan laser 100 and turning off the welding laser 600. In this case, the scan trajectory st may be formed to vibrate in the X-axis direction and proceed in the −Y-axis direction around the longitudinal direction of the jig 800, a line of symmetry with respect to the longitudinal direction of the jig 800, or an axis parallel to the Y-axis. The processor 400 may sense, recognize, or search the perimeter and position of the jig 800 by measuring a distance between the focus of the scanner 500 and the scanner 500.

According to this configuration of the present disclosure, the processor 400 may perform a more sophisticated welding operation by scanning, detecting, sensing, or recognizing the jig 800 before welding.

Referring to FIGS. 1 and 13, the jig 800 of the welding device according to an embodiment of the present disclosure may be configured to include a first part 810 pressing the electrode lead 40 and a second part 820 facing the first part 810. Also, the jig 800 may further include a third part 830 connecting the first part 810 and the second part 820, and a fourth part 840 connecting the first part 810 and the second part 820 and facing the third part 830. The first part 810 to the fourth part 840 may be configured to form a hole 801. In addition, the first part 810 to the fourth part 840 may have a rectangular shape. Also, the first part 810 to the fourth part 840 may be configured to press at least one of the electrode lead 40 and the bus bar 30.

According to this configuration of the present disclosure, the jig 800 may prevent flying products generated by the welding operation from splashing or spreading while stably pressing the electrode lead 40.

Referring to FIGS. 1 and 13, the processor 400 of the welding device according to an embodiment of the present disclosure may be configured to calibrate the preset welding work line based on coordinate information obtained by scanning the first part 810 and the second part 820. In this case, the processor 400 may be configured to calibrate the preset welding work line to the center line between the first part 810 and the second part 820.

In addition, the processor 400 may be configured to calibrate the preset welding work line based on coordinate information obtained by scanning the third part 830 and the fourth part 840. In this case, the processor 400 may be configured to calibrate the preset welding work line based on the center line between the third part 830 and the fourth part 840.

According to this configuration of the present disclosure, the processor 400 may calibrate or update the welding work line based on the first part 810 to the fourth part 840 of the jig 800. Since the first part 810 to the fourth part 840 form a rectangular shape, the center line between the first part 810 and the second part 820 or between the third part 830 and the fourth part 840 may improve the accuracy of calibration or update.

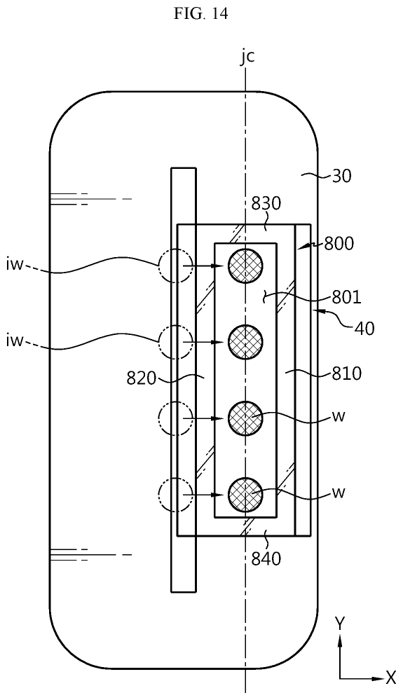

FIG. 14 is a view showing an example in which a welding line is calibrated by a welding device according to an embodiment of the present disclosure. Referring to FIGS. 1 and 14, the processor 400 of the welding device according to an embodiment of the present disclosure may be configured to calibrate or update the previously established, stored, and set welding work line iw by scanning, detecting, sensing, or recognizing the jig 800. For example, the processor 400 may calibrate or update the existing welding work line iw to the center line jc or line of symmetry jc of the jig 800. Alternatively, the processor 400 may calibrate or update the existing welding work line iw to the center line jc or line of symmetry jc between the first part 810 and the second part 820. Also, the processor 400 may be configured to form a welding spot w, a joint w, or a welding portion w along the calibrated or updated welding work line jc.

According to this configuration of the present disclosure, the processor 400 may improve welding quality and reduce welding defects by calibrating or updating the welding work line iw.

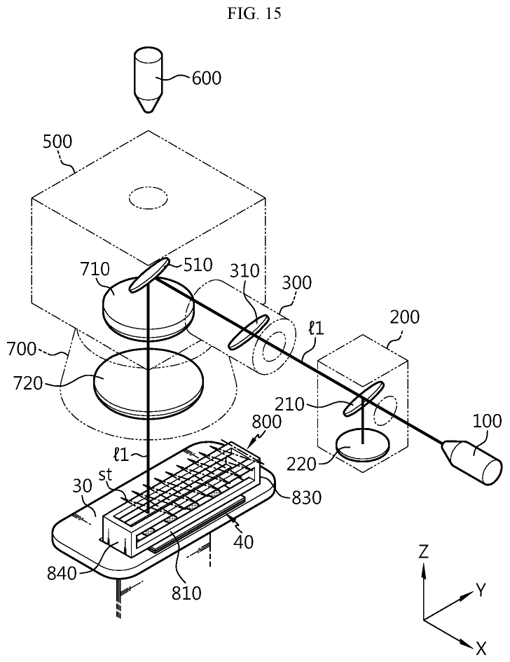

FIG. 15 is a view showing a bus bar 30 and an electrode lead 40 scanned by a welding device according to another embodiment of the present disclosure. Referring to FIGS. 1 and 15, the jig 800 of the welding device according to an embodiment of the present disclosure may be configured to press the electrode lead 40 and may be configured such that a hole 801 is formed to penetrate in the vertical direction. Also, the hole 801 may be configured to expose at least a portion of the electrode lead 40 and at least a portion of the bus bar 30.

The processor 400 may scan around the jig 800 by controlling at least one of the scanner 500 and the galvo module 300 while turning on the scan laser 100 and turning off the welding laser 600. In this case, the scan trajectory st may be formed to vibrate in the X-axis direction and proceed in the −Y-axis direction around the longitudinal direction of the jig 800, a line of symmetry with respect to the longitudinal direction of the jig 800, or an axis parallel to the Y-axis. The processor 400 may sense, recognize, or search the perimeter and position of the jig 800 by measuring a distance between the focus of the scanner 500 and the scanner 500. In addition, the processor 400 may sense, recognize, or search the boundary between the electrode lead 40 and the bus bar 30, or the edge or perimeter of the electrode lead 40 exposed through the jig 800.

According to this configuration of the present disclosure, the processor 400 may perform a more sophisticated welding operation by scanning, detecting, sensing, or recognizing the jig 800 before welding.

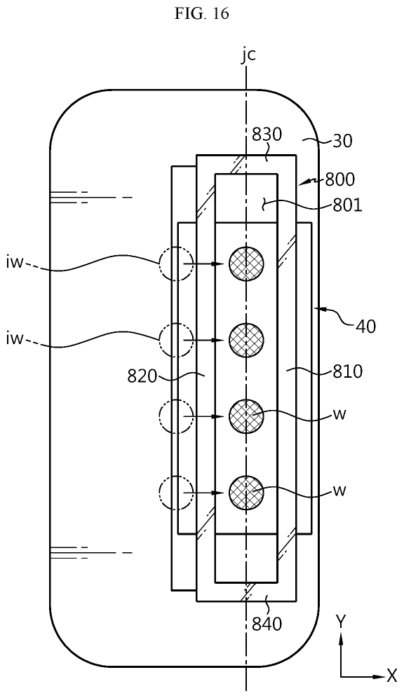

FIG. 16 is a view showing an example in which a welding line is calibrated by a welding device according to another embodiment of the present disclosure. Referring to FIGS. 1 and 16, the processor 400 of the welding device may be configured to calibrate or update the previously established, stored, and set welding work line iw by scanning, detecting, sensing, or recognizing the jig 800. For example, the processor 400 may calibrate or update the existing welding work line iw to the center line je or line of symmetry jc of the jig 800 with respect to the Y-axis direction. Alternatively, the processor 400 may calibrate or update the existing welding work line iw to the center line jc or line of symmetry jc between the first part 810 and the second part 820. Also, the processor 400 may be configured to form a welding spot w, a joint w, or a welding portion w along the calibrated or updated welding work line jc. In this case, the processor 400 may perform calibration or update of the welding work line iw with respect to the X-axis direction.

According to this configuration of the present disclosure, the processor 400 may improve welding quality and reduce welding defects by calibrating or updating the welding work line iw.

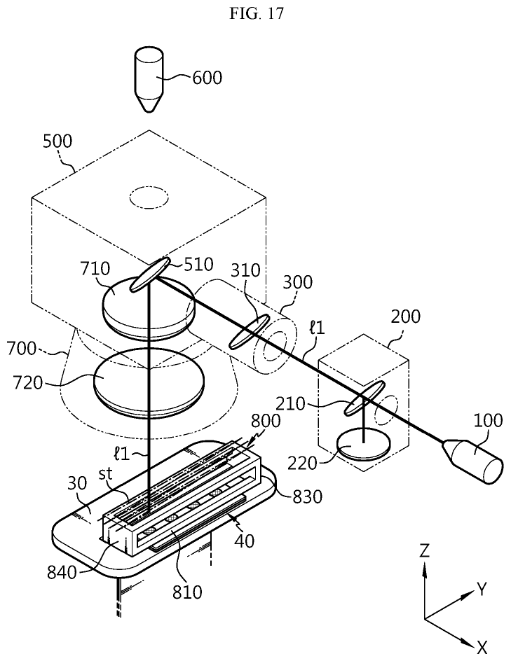

FIG. 17 is a view showing a bus bar 30 and an electrode lead 40 scanned by a welding device according to still another embodiment of the present disclosure. Referring to FIGS. 1 and 17, the processor 400 of the welding device according to still another embodiment of the present disclosure may scan around the jig 800 by controlling at least one of the scanner 500 and the galvo module 300 while turning on the scan laser 100 and turning off the welding laser 600. In this case, the scan trajectory st may be formed to vibrate in the Y-axis direction and proceed in the +X-axis direction around the longitudinal direction of the jig 800, a line of symmetry perpendicular to the longitudinal direction of the jig 800, or an axis parallel to the X-axis. The processor 400 may sense, recognize, or search the perimeter and position of the jig 800 by measuring a distance between the focus of the scanner 500 and the scanner 500. In addition, the processor 400 may sense, recognize, or search the boundary between the electrode lead 40 and the bus bar 30, or the edge or perimeter of the electrode lead 40 exposed through the jig 800.

According to this configuration of the present disclosure, the processor 400 may perform a more sophisticated welding operation by scanning, detecting, sensing, or recognizing the jig 800 before welding.

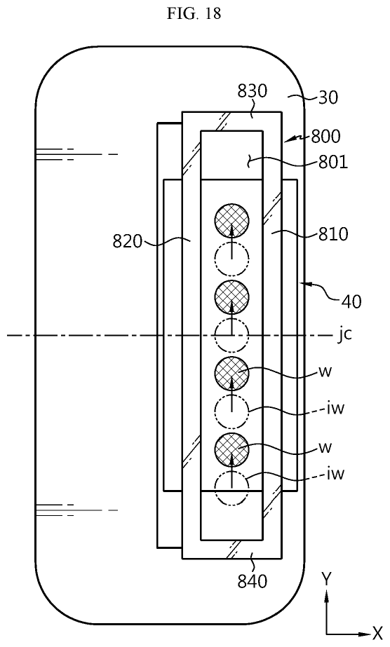

FIG. 18 is a view showing an example in which a welding line is calibrated by a welding device according to still another embodiment of the present disclosure. The processor 400 of the welding device according to an embodiment of the present disclosure may be configured to calibrate the preset welding work line iw based on coordinate information obtained by scanning the boundary of the bus bar 30 and the electrode lead 40. For example, the processor 400 may calibrate or update the existing welding work line iw to the center line jc or line of symmetry jc of the jig 800 with respect to the X-axis direction. Alternatively, the processor 400 may calibrate or update the existing welding work line iw to the center line jc or line of symmetry jc between the third part 830 and the fourth part 840. Also, the processor 400 may be configured to form a welding spot w, a joint w, or a welding portion w along the calibrated or updated welding work line jc. In this case, the processor 400 may perform calibration or update of the welding work line iw with respect to the Y-axis direction.

According to this configuration of the present disclosure, the processor 400 may improve welding quality and reduce welding defects by calibrating or updating the welding work line iw.

A battery cell according to one aspect of the present disclosure includes a welding spot, a welding joint, or a welding portion formed by the welding device according to the present disclosure.

In addition, a battery module according to one aspect of the present disclosure includes a welding spot, a welding joint, or a welding portion formed by the welding device according to the present disclosure.

In addition, a battery cell manufacturing device according to one aspect of the present disclosure includes a welding device according to the present disclosure.

In addition, a battery module manufacturing device according to one aspect of the present disclosure includes a welding device according to the present disclosure.

In addition, a welding method according to one aspect of the present disclosure uses a welding device according to the present disclosure.

Meanwhile, the terms indicating directions as used herein such as upper, lower, left, right, front, and rear are used for convenience of description only, and it is obvious to those skilled in the art that the term may change depending on the position of the stated element or an observer.

While the present disclosure has been hereinabove described with regard to a limited number of embodiments and drawings, the present disclosure is not limited thereto and it is obvious to those skilled in the art that a variety of modifications and changes may be made thereto within the technical aspects of the present disclosure and the equivalent scope of the appended claims.

1. A welding device for welding a plurality of materials arranged to be in contact, comprising:
a scanner configured to deflect light;
a welding laser configured to emit light toward the scanner;
a galvo module configured to deflect light toward the scanner;
a scan laser configured to emit light toward the galvo module; and
a processor configured to control at least one of the scanner and the galvo module to scan boundaries of the plurality of materials.

2. The welding device according to claim 1, wherein the processor is further configured to measure a distance between a focus at which the scanner is aimed and the scanner.

3. The welding device according to claim 1, wherein the processor is further configured to calibrate a preset welding work line based on coordinate information obtained by scanning the boundaries of the plurality of materials.

4. The welding device according to claim 1, wherein the processor is further configured to control the welding laser and the scanner to form a keyhole, and to control the scan laser and the galvo module to scan around the keyhole.

5. The welding device according to claim 1, wherein at least one of the plurality of materials is a frame of a battery module.

6. The welding device according to claim 1, wherein the plurality of materials comprise:
a first material; and
a second material laminated on the first material and exposing a portion of an upper surface of the first material,
wherein the welding device further comprises a jig configured to bring the second material into contact with the first material.

7. The welding device according to claim 6, wherein the first material is a bus bar, and
wherein the second material is an electrode lead of a battery cell.

8. The welding device according to claim 7, wherein the jig is configured to press the electrode lead, and a hole is formed to penetrate the jig in a vertical direction, and
wherein the hole is configured to expose at least a portion of the electrode lead and at least a portion of the bus bar.

9. The welding device according to claim 8, wherein the processor is further configured to calibrate a preset welding work line based on coordinate information obtained by scanning the boundary of the bus bar and the electrode lead.

10. The welding device according to claim 7, wherein the jig comprises:
a first part configured to press the electrode lead; and
a second part facing the first part.

11. The welding device according to claim 10, wherein the processor is further configured to calibrate a preset welding work line based on coordinate information obtained by scanning the first part and the second part.

12. A battery cell welded through the welding device according to claim 1.

13. A battery module welded through the welding device according to claim 1.

14. A battery cell manufacturing device comprising the welding device according to claim 1.

15. A battery module manufacturing device comprising the welding device according to claim 1.

16. A welding method using the welding device according to claim 1.

17. The welding device according to claim 1, wherein the processor is further configured to cause the scan laser to oscillate.

18. The welding device according to claim 6, wherein the processor is further configured to calibrate an existing welding work line to a center line of the jig.
